(19) United States
(12) Patent Application Publication
(10) Pub. No.: US 2007/0208718 A1
(43) Pub. Date: Sep. 6, 2007

(54) Method for providing web-based program guide for multimedia content

(76) Inventors: Sasha Javid, Boston, MA (US); Devasenapathi Seethararmakrishnan, Medford, MA (US); Stephanie Norton, Boston, MA (US)

Correspondence Address: Shivani Kaul, Esq.;Brown Rudnick Berlack Israels LLP, One Financial Center, Boston, MA, 02111, US

(21) Appl. No.: 11/713,318

(22) Filed: Mar. 2, 2007

Related U.S. Application Data
(60) Provisional application No. 60/778,895, filed on Mar. 3, 2006.

(51) Int. Cl. G06F 17/30

(52) U.S. Cl. 707/3

(57) ABSTRACT

A server for satisfying user requests for programming information pertaining to digital media. The server includes a communication facility for communicating with a plurality of users over a network, a plurality of receivers for receiving digital media content and its related metadata, an interface for receiving a user request for programming information pertaining to the digital media, an authentication mechanism between the user, a user authorized device, and a user profile on the server, a processor for interpreting the user request for digital media, a creator for creating instructions and for defining a graphical interface, a display mechanism for displaying the graphical interface, and a module for receiving client device capabilities for adapting displaying format of electronic program guides.

### RELATED APPLICATION INFORMATION

This patent application takes the priority of U.S. Provisional Application No. 60/778,895, filed in the U.S. Patent and Trademark Office on Mar. 3, 2006. The entire contents are incorporated herein by reference.

### FIELD OF THE INVENTION

This invention generally relates to a design of a user program guide, and more particularly to a design and an architecture of a Web-based program guide system for multimedia content.

### BACKGROUND OF THE INVENTION

Due to advances in computing and communication technologies, the media industry is moving towards three powerful innovations:
1. Digital content—media content is moving toward digital format. More importantly, media content is or will soon be tagged with meta information (such as ID3 and SMIL tags) that describe content so that it can be searched, analyzed and processed by computing devices.
2. Unification of media—due to the advent of interoperable networked devices and service and device discovery technologies such as ZeroConf, UPnP (universal plug and play) and DLNA (Digital Living Network Alliance), distinction between different media devices is disappearing. For example, a laptop computer can stream videos downloaded from the Internet to a television for viewing the program on a large screen.
3. High-capacity communication channels—due to widespread availability of high-capacity digital networks (such as DSL, cable, T1, 3G etc.) the volume of content that is distributed is increasing exponentially.

An average user is inundated with hundreds of channels and programs from a variety of content sources such as radio, Internet and television. Users need novel tools to find and consume content that they find useful and interesting. Conventional program guides are not able to fulfill this need because they suffer one or more of the following shortcomings:
1. Disparate guides—each type of media has a separate guide and users cannot search for contents across different media. For example, a guide for television programs does not include any information about radio broadcasts.
2. Static listings—usually program guides are neither searchable nor customizable. The programs are presented as static grids (time vs. channel) that present a scrolling list of programs in chronological order.
3. No user model—usually program guides do not consider user preferences and present all the programs as is without any consideration for users' likes and dislikes. For example, a user might not be interested in sports channels however, conventional program guides would list sports channels in the program listings.
4. No recommendation mechanism—conventional program guides only present a list of programs. They do not recommend any new content that might be of interest to users. Recommender systems are beneficial since they can help users find new programs that match their interests but would otherwise be unknown to them.

In U.S. Patent Application No. 20060294545 (the '545 application), a guide system is described that is coupled to a display device having a screen such as a television. The system displays media content on the screen and receives a command to display on the screen an electronic program guide. In response to the command, the system displays, concurrently with displaying the media content, a first dynamic video program within a first portion of the screen. The '545 application relates to viewing multiple programs on a single display via techniques of display sharing, therefore differing from the present invention.

In U.S. Patent Application No. 20060288366 (the '366 application), a program guide system is provided in which local advertisements may be distributed to interactive television program guides implemented on the user television equipment associated with a television distribution facility such as a cable system head-end. The local advertisements contain information that is directed toward the particular users in a local area. The local advertisements may be displayed when a user selects a related global advertisement. The '366 application teaches the delivery of customized advertisements to users according to their geo-location.

U.S. Patent Application No. 20060279657 (the '657 application) describes a display control device that includes a display control unit which displays two program guides side-by-side. The first program guide displays information on programs to be broadcasted on respective channels in a predetermined time period, and a second program guide displays information on programs to be broadcasted on a selected channel in respective time periods.

U.S. Patent Application No. 20060277575 (the '575 application) provides a method for delivering Electronic Program Guide (EPG) information using icons in a Digital Multimedia Broadcasting (DMB) receiver of a DMB system. A limitation of this DMB-based system is its inability to take user feedback and preferences into account.

U.S. Patent Application No. 20060259925 (the '925 application) specifies a program guide where display elements are arranged and styled using markup language documents. The program guide interprets the markup language documents and generates the display screens and program guide functionality without user intervention.

U.S. Patent Application No. 20060161425 (the '425 application) considers user input for program guide generation. As disclosed, the '425 application describes a system for providing an electronic program guide and a method of providing the same. The electronic program guide (EPG) is about a plurality of programs supplied through a digital broadcasting system, including analyzing a user's request and extracting EPG information that meets the user's request from the locally-stored EPG information to produce tailored EPG information. The '425 application further teaches that the tailored EPG information on the local client is converted into speech EPG information, and reproducing the speech EPG information as speech to provide users with the EPG information. A limitation of the system of the '425 application is that it provides for a feedback mechanism that alters user's preferences based on user feedback or actual usage.

U.S. Patent Application No. 20060130098 (the '098 application) describes a searching of an electronic program guide data. The EPG data may be compartmentalized into channel metadata that describes characteristics of one or more channels and content metadata that describes characteristics of one or more content items. The '098 application does not consider user feedback and user profiles to narrow down the search.

U.S. Patent Application No. 20060026645 (the '645 application) describes a system and a method for displaying a simplified electronic program schedule guide on a user's television monitor. The program guide screen visually distinguishes between programs for the convenience of the viewer. This work more particularly refers to a system and process for allowing a television viewer to access on-screen television program listings in an easy and convenient way. The '645 application does not consider program guides stored remotely that are able to dynamically capture programming information from multiple entertainment mediums such as digital television and digital radio.

U.S. Patent Application No. 20060020973 (the '973 application) teaches an electronic program guide (EPG) based method and system. The '973 application provides viewer/user groups with a program recommendation feature for predicting programs that are likely to be of interest. The method of the '973 application utilizes programming preferences of each member of a user group to determine a group profile, determining programming recommendations according to the group profile, and adapting an electronic program guide (EPG) page in response to the determined program recommendations. In the '973 application, any content and/or preferences that matches a group profile is pre-stored into a local set-top box, and then played for the group user.

In U.S. Patent Application No. 20060218590 (the '590 application), a method of displaying an electronic program guide on a display device is disclosed. The method displays the electronic program guide including visual indicators related to a perceived user interest level associated with a plurality of programs that may be displayed. The method includes determining a user preference level for each of the plurality of programs within the electronic program guide and assigning a visual indicator having a visual treatment that corresponds to the user preference level. The user preference level is indicated in accordance with a visual metaphor. The method also includes displaying the electronic program guide including the visual indicators on the display device.

U.S. Patent Application No. 20050114340 (the '340 application) relates to a method, system, and storage medium for providing adaptive programming listings over a network. The method includes presenting a user interface to a customer entity along with the program recommendation guides, receiving at least one selection from the program recommendation guides, and storing the selection in a customer preference database. This relies on gathering recommendation guides from third parties and storing both recommendation guides and content for the user. This approach does not have any flexibility to adapt its recommendation guide according to usage and real-time user feedback. In addition, the '340 application does not consider programming information from multiple platforms such as digital radio and digital television feeding into the program guide.

In U.S. Patent Application No. 20030233241 (the '241 application), various embodiments provide ways to collect, organize and process metadata associated with particular instances of media content. Methods and systems can also make use of user-specific data to evaluate various media content and then make recommendations as to which content a user would most likely wish to experience. Such user-specific data can comprise one or more user preference files that contain information associated with individual users, and one or more significance files that hold values, for individual users, that can be used to determine the significance of any matches found between the user preference files and media content. These user preferences files are at least partially stored on local storage clients. A limitation of the '241 application is that it only deals with television or movie content rather than other media platforms such as digital radio.

In U.S. Patent Application No. 20020199188 (the '188 application), a method for customizing a video service in a content distribution system is disclosed. In one step, preference information entered by a user of the content distribution system is received and influences the profile for that user. Interaction of the user with the video service is observed to influence the profile. The video service is customized based, at least in part, on the profile. A program guide is generated and customized according to the profile. The profile is modified to remove older interaction information. The claims around preference creation deal with preferences that are created on the local client and do not come from a web service. Limitations of this system include the requirement that users to provide feedback manually to initially create profiles and the fact that these stored profiles deal with video services only rather than other digital platforms like digital radio.

### SUMMARY OF THE INVENTION

It is an object of the present invention to create a customizable and real-time electronic program guide (“EPG”) for all different media types.

It is also an object of the present invention to disclose a server for satisfying user requests for programming information pertaining to digital media. The server includes a communication facility for communicating with a plurality of users over a network, a plurality of receivers for receiving digital media content, an interface for receiving a user request for programming information pertaining to digital media, an authentication mechanism between the user, the user's authorized devices and the user profile on the server, a processor for interpreting the user request for digital media, a creator for creating instructions and for defining a graphical interface, in response to the user request for digital media, a display mechanism for displaying the graphical interface, and a module for receiving client device capabilities for adapting displaying format of electronic program guides.

In another embodiment of the present invention, the display mechanism displays an interactive slide bar corresponding to channels of the requested digital media.

In yet another embodiment of the present invention, the slide bar responds to the user designation of a channel by displaying graphical content corresponding to digital media programs associated with the channel, facilitating access to a program upon user selection thereof, and displaying context-sensitive advertisements and information.

Another embodiment of the present invention further includes a user profile database for storing user preferences and user device capabilities. The graphical content displayed in response to the user's designation is partially determined by stored user preferences and user device capabilities.

### BRIEF DESCRIPTION OF THE DRAWINGS

FIG. 1 illustrates a program guide architecture in which the personalized program guide is stored onto a set-top box;

FIG. 2 is a block diagram that illustrates exemplary components including a networked media server and a local or client device, according to the present invention, in which the EPG is provided in real-time without a need for a local storage device, and also local device capabilities are used an input to the media server for crafting the EPG;

FIG. 3 is a screen shot of an exemplary EPG grid that is presented to an end user, according to the present invention;

FIG. 4 is a screen shot of an exemplary EPG grid that is presented to an end user when he/she queries for more detailed programming information; and

FIG. 5 is a block diagram that illustrates exemplary components including networked media guide server, a local or client device and a networked-controlled media player.

### DETAILED DESCRIPTION OF THE PRESENT INVENTION

The present invention provides a universal web-based program guide that is user-specific and includes a powerful recommender system. According to an embodiment of the present invention, the system includes server and client side components.

The present invention utilizes content metadata. The term “metadata” includes, but is not limited to, signal quality, tuning information, program titles, artists or actors, plots, lyrics, and the like. The metadata is used to create a customizable and real-time electronic program guide (“EPG”) for all different media types, including digital radio. Digital radio play-lists are typically not published in advance of airing. Therefore, real-time analysis of the content metadata from digital radio broadcasts at a web server and creating a real-time guide from the analysis results is important. The present invention provides an integrated real-time search mechanism for content from different sources of media. If the media player is connected to a media server over the network, the search process can be executed on a server. On the other hand, if the media player does not have connectivity, the search process can be performed locally at the client using the receivers available locally. If the search is done on the server, the customized program guide returned to the user is bandwidth-efficient, since only the relevant programming information is communicated over the network. Additionally, having user profiles and recommender system stored on the media server allows personalized EPG information to be sent to any type of networked device (e.g., phone, networked digital radio, or PC) after a user's identity has been established using authentication procedures such as password authentication and/or smartcard technologies. Furthermore, at the server, multiple receivers can be utilized for each platform (e.g., digital radio) making the immediate notification in a change of programming possible. The present invention employs a recommender system to recommend new programs to users based on their preferences and the preferences of people with similar tastes, and also based on user device capabilities. The present invention also has an adaptive display mechanism that reconfigures itself to the characteristics of client display. The client can run on networked devices and can control media players over local area networks. The client employs a slide bar for the EPG which provides intuitive interface. Since the user preferences are digitally recorded, context-sensitive advertisements, and information presented to the users can be customized according to their preferences. Since the user preferences, user profiles and consumption patterns are available as digital data on central servers, several data mining algorithms can be used to analyze the data to determine content consumption patterns (based on age, sex, region, etc.) and to perform media research.

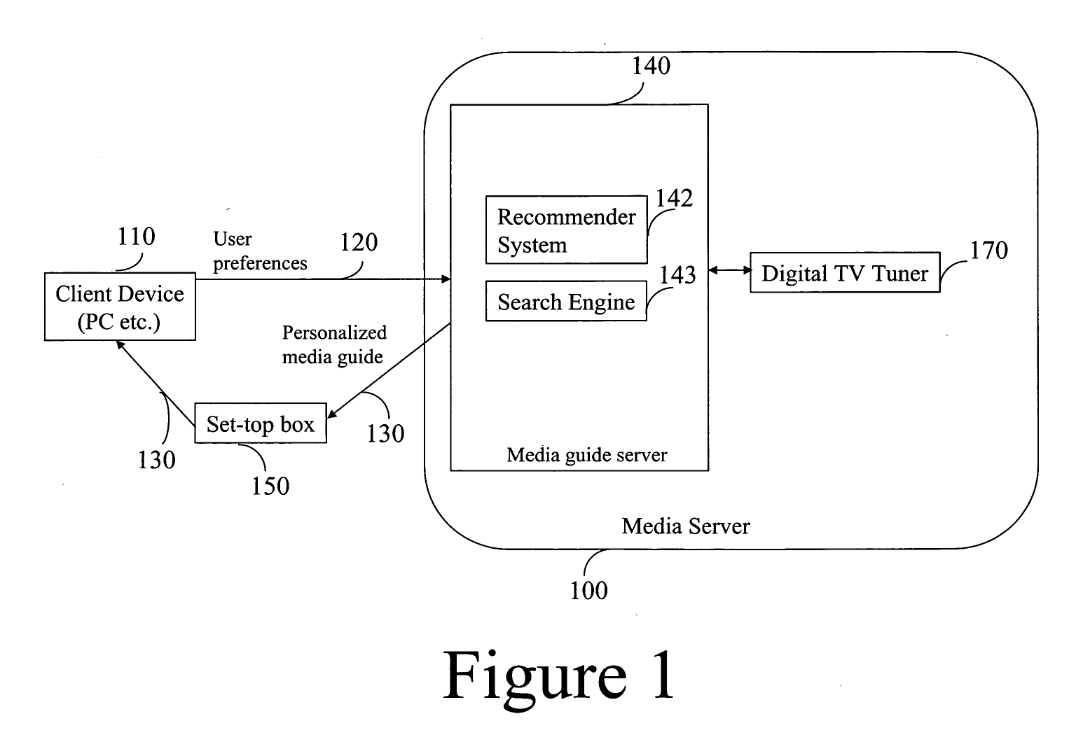

The key component of the present invention is that user preferences are stored on a web server and that program listings are collected in real-time via constant scanning of the different channels in each digital content medium. As shown in FIG. 1, set-top box 150 stores a personalized media guide 130, including programming information and user profiles, downloaded from media server 100 and renders upon request this information to the client device 110. Storing programming information locally on a set-top box 150 works for digital content mediums where programming schedules are pre-announced (e.g., digital television) but not for digital content mediums where pre-announced schedules do not exist (e.g., digital radio). It also does not allow for automatic tuning of any client device 110 that plays digital content without pre-announced schedules since programming information on set-top box 150 would be out of date. In fact, FIG. 1 only shows programming information 130 being collected on the media server 100 from a digital TV tuner 170. By removing the set-top box 150 from the architecture, the present invention also allows for more diverse and remote client devices 110 to leverage the programming information 130 and user profiles sitting on the server as long as a network connection exists.

### Server-Side Components

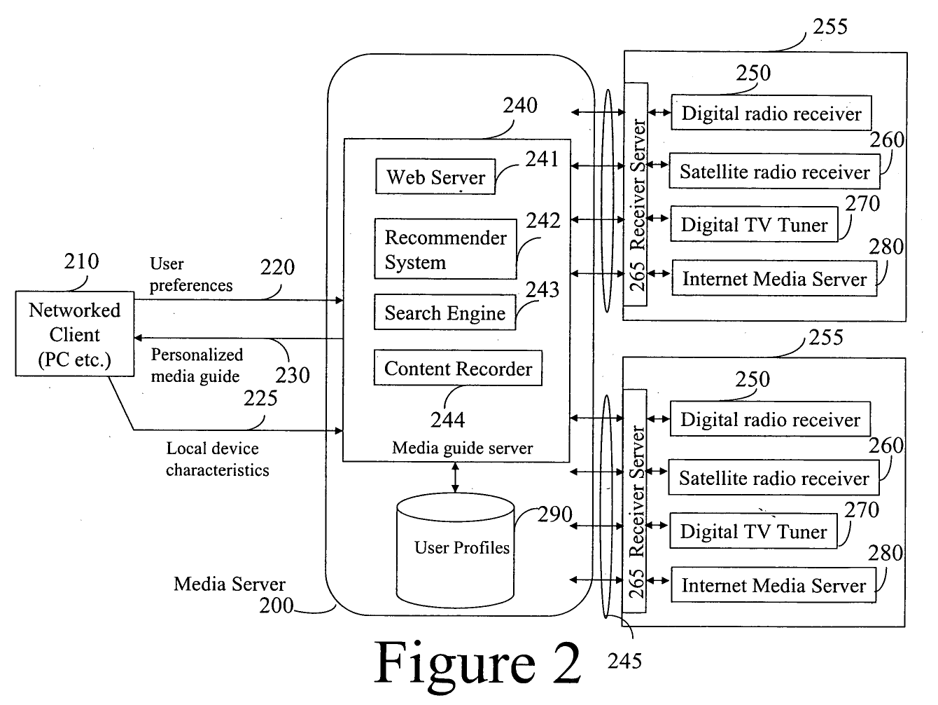

As shown in FIG. 2, a media server 200 includes a media guide server (MGS) 240 and a user profile database 290. A receiver platform 255 includes a receiver server 265 and a plurality of other receivers. These receivers include a digital radio receiver 250, a satellite radio receiver 260, a digital TV tuner 270 and an internet media server 280. Each receiver platform 255 may be remotely located from the media server 200 and connected to one another over a wide area network such as the Internet or a local area network such as an Ethernet.

MGS 240 includes a web server 241, a recommender system 242, a search engine 243 and a content recorder 244. The web server 241 deals with all web requests from the networked clients 210. The recommender system 242 suggests new content to users based on their profile and interests. The recommender system 242 may be based on any appropriate technique such as collaborative filtering, social data mining, content filtering, expert suggestions or any combination of these techniques. The search engine 243 searches and returns a personalized media guide 230 based on a user's direct preferences 220 and the input from the above-mentioned recommender system 242 application. The returned media guide 230 is graphical and interactive. (This guide is described in detail in connection with the client-side components.)

The content recorder 244 is used to time-shift programs upon user requests. A program of interest specified by the user is recorded and played back to the user at a later time the user wants.

The receiver platform 255 receives content from at least one content provider and feeds the content metadata, content-provider related metadata (such as ID3 tags or SMIL tags) and the content itself to the search engine 243 executing on media server 200. A receiver platform 255 may be located in each major city across the United States to conduct real-time scans of various entertainment mediums such as digital radio to gather real-time programming information and to feed it back to a single media server 200 in a data center. User Profile database 290 is a multi-dimensional database of user preferences, because it stores user preferences for channels, media and programs.

### Client-Side Components

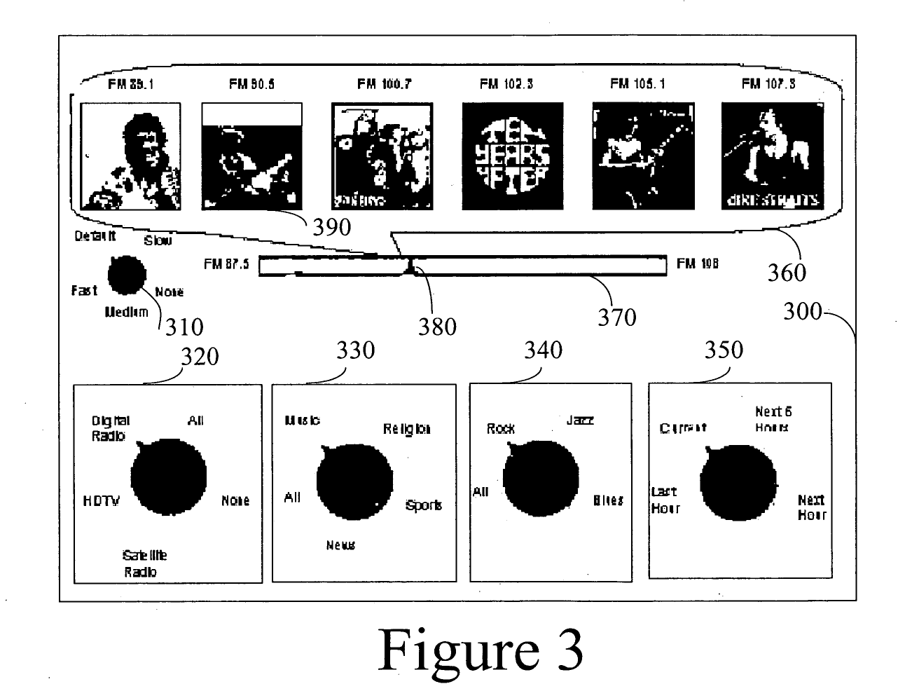

As shown in FIG. 2, the media guide client retrieves the guide 230 over the web. The guide 230 is fully customizable. The user interface is illustrated in FIG. 3.

For example, the guide shown in FIG. 3 includes a media slide 370, a sliding selection panel 360, and various selection options represented in this exemplary system by virtual knobs (320, 330, 340 and 350). The guide interface is not limited to only these components and the display shape and format can be implemented using appropriate user interface components. For example, the knobs in FIG. 3 could be replaced by drop down menus or some other selection filter. One or more knobs are used to control the user choice for content. At least one knob 320 is used to choose the type of media. For example, a knob may be used to make a selection between HDTV programs, digital radio programs, satellite radio programs, etc. Another knob 330 may be used to specify the type of programs (e.g., music, religion, sports, etc). Also, a knob 340 may be used to further refine the program choices. For example, if knob 330 is used for program type, and is set to music, knob 340 set for refinement may be used to select the music genre such as rock, classic, country, etc. Finally, knob 350 may be used to select the time frame for playing the selected content. For example, the user may choose to listen to the selection an hour later. The list of programs presented on the user interface 300 includes the programs that match the selections indicated by current knob settings (320, 330, 340, 350). For example, the user on the networked client 210 chooses Digital Radio 250 via knob 320, Music channels via knob 330, and more specifically, Rock Music via knob 340. Presentation by the media guide 230 is limited only to a list of rock music programs that are currently playing on the Digital Radio 250.

The media slide 370 presents the list of selected programs in their chronological play order in the sliding selection panel 360. The pace at which the panel 390 slides may be controlled using the pace knob 310. Moreover, the user operating the networked client may browse the list of programs by moving the probe 380 of the slider bar 370.

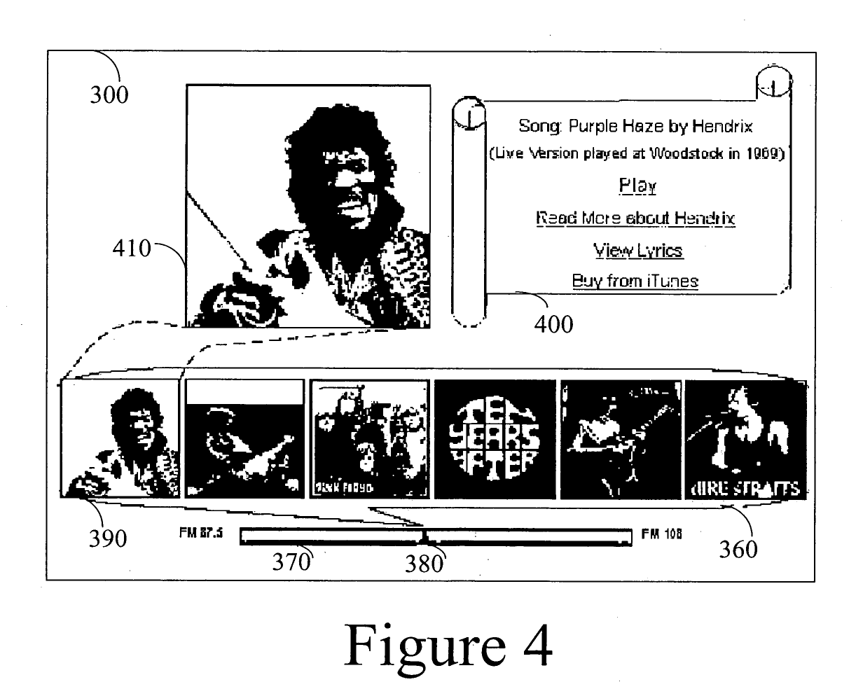

As shown in FIG. 4, the selection panel 400 presents information about the selected program 410 from the sliding panel programs 390, if a user clicks on any specific program. For example, if the user selects a song, the selection panel 400 may provide one or more links to the artist's website, song lyrics, “option to buy” and to Play.

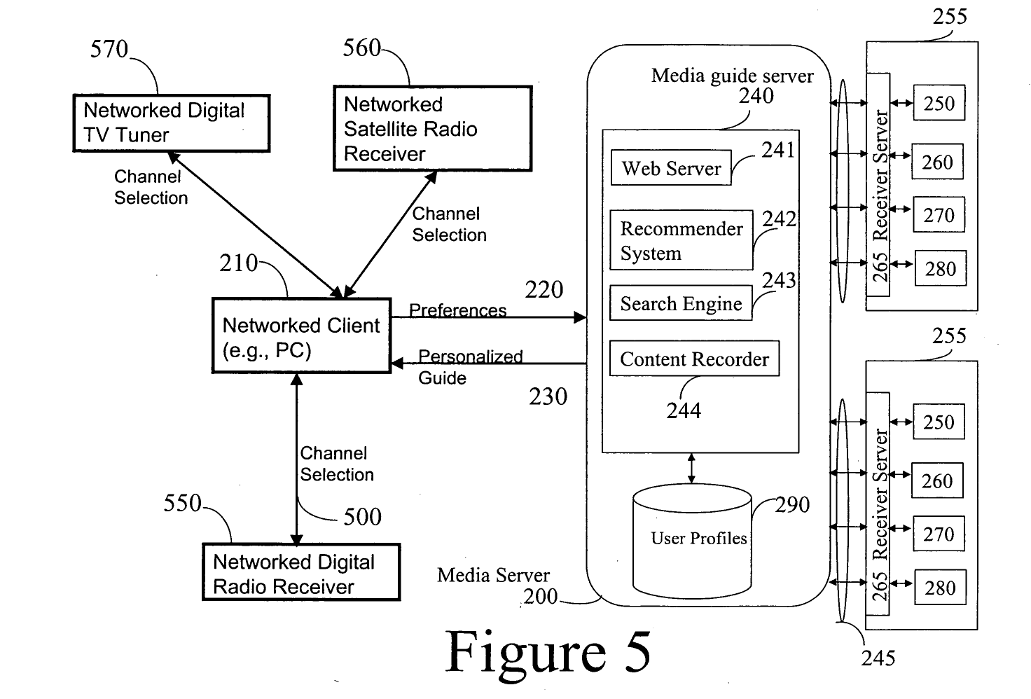

If the client is not connected (over a wired or wireless physical medium) to media players such as radios 550, 560 and television 570, users operating the networked client 210 manually tune receivers 550, 560, 570 to play the selected program. On the other hand, if the networked client is connected to appropriate appliances as illustrated in FIG. 5, the selected program can be played by clicking the “Play” link in the selection panel 400. The connection between the networked client 210 and the appliances 550,560,570 need not be a network, it may also be a direct interface such as PCI or USB or PCMCIA.

### Exemplary System 1:

FIG. 2 illustrates an exemplary system in the form of a networked media server 200 and remote receiver platform 255. The media server 200 contains conventional computer components, including a processor, memory, mass storage, application and operating-system software, and the like, as well as appropriate device and network interfaces. The media server's 200 key component is the media guide server 240. The media server 200 also contains user profiles 290, but this may or may not be hosted on the same server as the media guide server 240. The media server 200 collects from the receiver platform 255 real-time metadata information associated with content from various entertainment providers. The source of this metadata may include, without limitation, a digital radio receiver 250, a satellite radio receiver 260, a digital television tuner 270, and/or an Internet Media Server 280. When insufficient programming information is provided or published, frequency scanning may be conducted by the receiver server 265.

In the system illustrated in FIG. 2, frequency scanning is performed at the receiver platform 255 by the receiver server 265 utilizing multiple receivers of each medium 250, 260, 270, 280 (e.g., multiple digital radio receivers) and, if desired, a suitable search algorithm to improve the efficiency of a scanning process.

The networked client 210 queries the metadata collected from the multiple receiver platforms 255 via the media server 200 when prompted by the end user. After the user identity of the networked client 210 is established via traditional authentication methods such as password authentication or using smartcard technologies, the media guide server 240 responds with the relevant metadata to fulfill a request for the production of a personalized EPG for one or more of the different sources of media content (e.g., digital radio 250, satellite radio 260, digital television 270, Internet radio 280). The metadata requested from the media guide server 240 may also be used to respond to a search of media requested by the end user from the networked client 210. The EPG desirably displays only relevant search results, or is at least organized in such a way that the most relevant search results are displayed first. The networked client 210 is typically a PC or home media server.

Via user authentication, the media guide server 240 has awareness of the type of networked client 210 allowed for use by the user and automatically customizes both the actual metadata and its format to ensure it is appropriate for the client's display capabilities. For example, a networked client 210 such as a networked media player may have more limited display capabilities than a networked PC or television. This adaptive display is highly advantageous.

The metadata queried from the media guide server 240 can be set by the end user at the networked client 210 based on settings entered manually by the end user at the time of the query (e.g., location or zip code) or based on a user profile 290 stored on or connected (locally or remotely, via computer network) to the media server 200 and entered previously by the end user. For example, user profiles may be stored on a mass-storage device, such as a hard disk, in a database format. These settings facilitate personalized EPGs and search results being displayed on networked client 210.

Searches that query the media guide server 240 from the networked client 210 may not be just of the metadata used for programming guide purposes, but also of the content itself. For example, if the end user wishes to search for talk radio discussions on Tom Brady of the New England Patriots, the media guide server 240 will ask the receiver server 265 in one or all appropriate markets to conduct a real-time scan of actual content tagged in each channel of the digital radio 250 or satellite radio 260 after being queried from the networked client 210.

The media server 200 may also serve as a host of original content including, but not limited to, user-generated community information (e.g., reviews, most popular lists, blogs, bulletin boards) and streamed web-casts. User-generated data may be entered via a networked client 210 such as a PC. User-generated data that the end user wants to save may be stored in the user profiles 290 (e.g., within a database field) connected to the media server 200.

The media guide server 240 may also serve as a cache for content requested by the end user via the networked client 210. This cache would be stored on the content recorder 244 of the media guide server 240. The end user may view/listen this cached content at a later time for his/her convenience. Similarly, the networked client 210 can also reach the cached content stored on the media guide server 240. The media guide server 240 and the networked client 210 can be connected over a cellular network such as GSM (Global System for Mobile Communications), and the networked client 210 can be a mobile device such as cellular phone.

The media server 200 also serves as a data aggregator of both end user data and content provider data and can generate reports and data dashboards from this data. Data regarding the listening/watching habits of end users, as well as data regarding the programming content of broadcasters, may also be captured in the media server 200.

If prompted by the end user from the networked client 210, the media guide server 240 acts as a recommender of current content playing across any medium (e.g., digital radio 250, satellite radio 260, digital television 270 or Internet radio 280), to which the server has access based on user preferences in the user profiles 290 and, if desired, an intelligent recommender system 242 executing on (or accessible to) the media guide server 240. As its name suggests, this recommender system 242 can also be used to share user preferences between multiple user profiles 290 if allowed by the end user.

An exemplary display for an EPG is shown in FIG. 3. One feature is a slide bar 370 that displays, using a frequency indicator 380, the exact channel or frequency from which programming information is being displayed. The slide bar 370 and the sliding selection panel 360 provide a viewer-friendly approach to displaying programming information while overcoming one of the key annoyances with traditional grid displays—namely, not knowing how long it will take to scroll through the entire list of channels. In FIG. 3, a slide bar is used to display digital FM stations, but of course, it can just as easily display other digital media sources such as digital television, satellite radio or Internet radio.

In some embodiments, the sliding selection panel 360 containing programming information adjusts as the end user moves the frequency indicator 380 along the slide bar 370.

The default data first shown in the sliding selection panel 360 may be based on a query of programming information available in a certain location or zip code. This information is sent from the media guide server 240 to the networked client 210. Location information is provided either manually by the end user or based on a user profile 290 connected to or hosted on the media server 200. Location information may also be derived from the network identity of the networked client 210. For example, the geographical location of a networked client can computed from its IP (Internet Protocol) address.

The size and format of the programming information in the sliding selection panel 360 may be either manually or automatically adjusted according to the display capabilities available on the networked client 210. For example, an LCD on a digital media server may show only one line of data. The information displayed in this sliding selection panel 360 is adjusted to accommodate this limitation.

The speed at which the frequency indicator 380 moves across the slide bar may be set manually via a selection option—in one embodiment, a virtual knob 310. The speed may also be set in a user profile 290 that is connected to or hosted on the media server 200. The speed at which data panels 390 appear and fade inside the sliding selection panel 360 may be also set manually via a virtual knob 310. The speed may also be set in a user profile 290 that is connected to or hosted on the media server 200.

A source of digital media content (e.g., digital radio, digital television, Internet radio or all) will be displayed on the EPG and will populate the slide bar 370 and the sliding selection panel 360 may be set manually via a virtual knob 320. The source may also be set in a user profile 290 that is connected to or hosted on media server 200.

The programming format (e.g., music, talk, religion, news, all, etc.) displayed in slide bar 370 and in the data of the sliding selection panel 360 may be set manually via a virtual knob 330. The options displayed on the general format virtual knob 330 are dictated by the digital sources selected using the source virtual knob 320. In FIG. 3, the displayed formats are representative of various digital radio formats. The format may also be set in a user profile 290 that is connected to or hosted on the media server 200.

Further programming format customization (e.g., rock, classical, blues, jazz, all, etc.) displayed in slide bar 370 and the sliding selection panel 360 may be set manually via a virtual knob 340. The options displayed on this refined format virtual knob 340 are dictated by the digital sources selected using the source virtual knob 320 and the general format knob 330. In FIG. 3, the displayed formats are representative of various digital radio music formats. The format may also be set in a user profile 290 that is connected to or hosted on media server 200. Although a digital radio music format is shown here, any digital format may be implemented.

The time frame of programming information that is displayed in the sliding selection panel 360 may be set manually via a virtual knob 350. The timeframe may be just current listings, but also past and/or future listings. The timeframe may also be set in a user profile 290 that is connected to or hosted on the media server 200.

Additional user-defined preferences for the format and content of the EPG may be set in a user profile 290 that is connected to or hosted on the media server 240.

An exemplary display of detailed program information and end user options is shown as part of an EPG in FIG. 4. Clicking on one of the data panels 390 that appears in the sliding selection panel 360 causes more detailed content information to be queried from the media guide server 240 and displayed in the additional data balloons 400. The data appearing in these additional data balloons 400 may include, for example, artist information, actor information, lyrics, plot, user-generated information such as links to blogs, purchase content options and context-sensitive advertisements that are relevant to the song/program being played. In FIG. 4, the additional data balloon 400 displays information and options related to Jimi Hendrix's song Purple Haze playing on digital FM radio station FM 89.1. The data that appears in additional data fields 400 (also referred to as balloons) is customizable depending on the display capabilities 225 of the networked client 210 and the user profile 290 that is connected to or hosted on the media server 200.

How the information that provides the content for the additional data fields 400 is queried may involve, for example, clicking on the less detailed data panel 390, automatic queries determined by user profiles 290 connected to or hosted on the media server 200, and/or some form of voice-activated query. The purchase of content options, for example, may include “click to purchase options” from cached content stored on the media guide server 200 or links to other music purchasing websites (e.g., iTunes, YahooMusic, etc.).

### Exemplary System 2:

FIG. 5 illustrates an exemplary system that builds on the architecture displayed in FIG. 2 and the functionality discussed in detail throughout Exemplary System 1. The system discussed in Exemplary System 2 and shown in FIG. 5 includes a networked media guide server 240 and a networked client 210, and also includes networked media tuners and receivers (550, 560, 570) that extend out from the networked client 210 via a network or local connection. These networked media tuners/receivers may be, for example, networked digital radio receivers 550, networked satellite radio receivers 560 and/or digital television receivers 570.

After the user of these networked tuners/receivers (550, 560, 570) is identified using traditional authentication procedures such as password authentication or using smartcard technologies, these devices can be controlled either manually (by end user manipulation of the EPG displayed on the networked client 210) or automatically (by preferences entered at time of use by the end user or previously as part of a user profile 290). For example, in the case of digital broadcast radio, the networked digital radio receiver 550 may be controlled by user preferences that were queried from the media server 200 by the networked client 210. Thus, if an existing user preference is to only listen to Eric Clapton music on the digital radio, a real-time frequency scan may be requested by the media server 200 to run on one or all of the appropriate receiver servers 265 after receiving the login information from the networked device 210. Then programming information regarding what broadcast radio stations are currently playing Eric Clapton is sent back down to the networked device 210 and displayed in the EPG. If the user indicated a setting of “autopilot mode” for the networked digital radio receiver 550, the programming information 500 will be sent on to the digital radio receiver 550, which will tune into this frequency with no user involvement.

The networked client 210 and the networked digital tuners/receivers (550, 560, 570) may not always be connected to the IP network. In this scenario, the networked digital tuners/receivers (550, 560, 570) can still operate based on the user preferences last downloaded as client software on the non-networked client 210 from the user profiles 290. These non-networked digital tuners/receivers (550, 560, 570) have at least one receiver which allows them to be controlled by the non-networked client 210 software. Thus, client software running on the non-networked client 210 acts in a similar fashion to the software running on the receiver servers 265 and the media guide servers 240. The key difference is that the content search is performed by the receiver in the digital tuner/receiver (550, 560, 570) after frequency scanning. In the case of one receiver, frequency scans are performed following the end of a defined piece of content (e.g., a song or movie). In a scenario where two or more receivers are present in the digital tuner/receiver (550, 560, 570), one receiver is dedicated to playing content, while the other receivers are used for frequency scanning.

The media guide server 240 has awareness of the type of networked client 210, as well as of the type of digital tuner/receiver (550, 560, 570), facilitating automatic customization of both the actual metadata and its format to ensure facilitating suitability for the display capabilities of both the networked client 210 and digital tuner/receiver (550, 560, 570), if there is an LCD functionality.

While the present invention and its embodiments have been described in detail, it will be apparent to those skilled in the art that the principles of the invention are readily adaptable to other implementations and system configurations and communications paradigms without departing from the scope and the spirit of the invention, as defined by the following claims.

1. A system comprising a server for satisfying user requests for programming information pertaining to digital media, the system comprising:
a. a communication facility for communicating with a plurality of users over a network;
b. a plurality of receivers for receiving digital media content and its related metadata;
c. an interface for receiving a user request for programming information pertaining to said digital media;
d. an authentication mechanism between said user, a user authorized devices and a user profile on the server;
e. a processor for interpreting said user request for digital media;
f. a creator for creating instructions and for defining a graphical interface, in response to said user request for digital media;
g. a display mechanism for displaying said graphical interface; and
h. a module for receiving client device capabilities for adapting displaying format of electronic program guides.

2. The server of claim 1, wherein said display mechanism displays an interactive slide bar corresponding to channels of said requested digital media.

3. The server of claim 2, wherein said slide bar responds to a user designation of a channel by displaying graphical content corresponding to digital media programs associated with a channel, facilitating access to a program upon user selection thereof, and displaying context-sensitive advertisements and information.

4. The server of claim 1 further comprising a user profile database for storing user preferences and user device capabilities, the graphical content displayed in response to the user's designation being partially determined by stored user preferences and user device capabilities.

5. The server of claim 1 further comprising a scanner for scanning said digital media to obtain metadata specifying channels and digital media programs associated therewith.

6. The server of claim 1, wherein the graphical interface further responds to a user search queries by searching metadata associated with the digital media for matches to the queries and displaying graphical content corresponding to programs having matching metadata.

7. The server of claim 1, wherein the graphical interface further responds to user search queries by searching digital media programs for matches to the queries and displaying graphical content corresponding to programs having content matching the queries.

8. The server of claim 1, wherein the network comprises wireless and wired connections.

9. The server of claim 1, wherein said plurality of receivers may be remotely networked to said server.

10. The server of claim 1, wherein said plurality of receivers includes digital radio receivers.

11. The server of claim 1, wherein content selection and tuning is done automatically without user intervention based on said user profile.

12. The server of claim 1 further comprising at least one tuner, automatically and without user intervention, for content scanning, selection and tuning based on user profile that is cached locally.

13. The server of claim 1 further comprising a recommendation facility for recommending currently available programs to the user based on the user profiles and past usage history.

14. The server of claim 1 further comprising a feedback mechanism to enhance user profiles automatically based on user habits.

15. The server of claim 1, wherein the graphical content comprises data fields containing programming information, a sliding selection panel adjusting its data panels as the user moves an indicator along the slide bar.

16. A method for satisfying user requests for programming information pertaining to digital media, the method including:
a) establishing a communication with at least one user over a network;
b) receiving digital media content and its related metadata in real-time;
c) receiving at least one user request for said digital media content;
d) authenticating said at least one user and a user device to allow access to a user profile;
e) interpreting said at least one user request in real-time for digital media;
f) creating instructions for defining a graphical interface in response to said at least one user request for digital media;
g) displaying said graphical interface to said user; and
h) receiving a client device capability for adapting a display format of an electronic program guide, in relation to said user.

17. The method of claim 16, wherein said graphical interface adjusts data fields, related graphical fields, an access mechanism to selected programs upon selection thereof, and a context-sensitive advertising and information in the slide selection panel as said user moves an indicator along a slide bar.

18. The method of claim 16, wherein said receiving digital media content step is performed with digital radio receivers.

19. The method of claim 16 further comprising:
selecting content and tuning automatically, without user intervention, based on said user profile or a recommendation facility; and
automatically updating said user profile without user identification.

20. A method for satisfying user requests for programming information pertaining to digital media, the method including:
a) establishing a communication with at least one user over a network;
b) scanning digital media content and its related metadata in real-time;
c) receiving at least one user request for said digital media content;
d) authenticating said at least one user and a user device to allow access to a user profile;
e) interpreting said at least one user request in real-time for digital media;
f) creating instructions for defining a graphical interface in response to said at least one user request for digital media;
g) displaying said graphical interface to said user; and
h) receiving a client device capability for adapting a display format of an electronic program guide, in relation to said user.
